(19) United States
(12) Patent Application Publication
(10) Pub. No.: US 2023/0105250 A1
(43) Pub. Date: Apr. 6, 2023

(54) SELF-ENCRYPTING DEVICE (SED) SETUP SYSTEM AND METHOD

(71) Applicant: Dell Products, L.P., Round Rock, TX (US)

(72) Inventors: Pushkala Iyer, Round Rock, TX (US); Sanjeev S. Dambal, Austin, TX (US); Vigneswaran Ponnusamy, Leander, TX (US); Matthew J. Maze, Georgetown, TX (US); Saranya Shanmugam, Kanata (CA)

(73) Assignee: Dell Products, L.P., Round Rock, TX (US)

(21) Appl. No.: 17/492,795

(22) Filed: Oct. 4, 2021

(51) Int. Cl. H04L 9/32; H04L 9/08

(52) U.S. Cl. CPC H04L 9/3268; H04L 9/0819

(57) ABSTRACT

A self-encrypted drive (SED) setup system uses a systems manager executable program that stores user account information associated with an External Key Management Server (EKMS) service provided by an EKMS in which the user account information has a unique identifier of an associated Information Handling System (IHS). Using the stored user account information, the systems manager may setup a secure encrypted drive (SED) on the IHS by generating a Certificate Signing Request (CSR) for the IHS, communicate with a Certificate Authority (CA) associated with the EKMS to obtain a signed CSR and an EKMS certificate, and load the signed CSR and the EKMS certificate on the IHS when the IHS is to be registered for use with the EKMS. The EKMS service is configured to provide a key for the computing device.

### FIELD

This disclosure relates generally to Information Handling Systems (IHSs), and more specifically, to a self-encrypting device (SED) setup system and method.

### BACKGROUND

As the value and use of information continues to increase, individuals and businesses seek additional ways to process and store information. One option is an Information Handling System (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware, and software components that may be configured to process, store, and communicate information and may include one or more computer systems, data storage systems, and networking systems.

Modern day computing resources are provided by large computing environments that may include server farms, computer clusters, individual computing devices, and/or data centers. Computing environments are generally associated with large organizations, such as business enterprises to educational institutions such as universities. In many cases, larger organizations may manage multiple server farms over a diverse geographical region. Nevertheless, management of such large, diversified computing environments are typically provided by remotely configured system management consoles. OpenManage Enterprise is one example of a system management console provided by Dell Technologies, which cost-effectively facilitates comprehensive lifecycle management for the computing devices of distributed computing environments from one console.

Many information handling systems such as computing devices configured in data centers, may employ enhanced security by locking managed devices within the computing devices with device locking keys. For example, many of these computing devices have been developed to provide for the centralized management of device locking keys via in-band methods (e.g., using operating system services provided via an application or agent running in the operating system on the server system) or out-of-band methods (e.g., via a remote access controller that operates independently of the operating system and uses a dedicated network connection to the key management system that is separate from that used by the operating system), and use those device locking keys to unlock managed devices for use. For example, managed devices such as Self Encrypting Drives (SEDs) operate to encrypt data for storage using a remote key management service commonly referred to as an External Key Management Server (EKMS). Thus, prior to placing the SED configured computing device in service, it registers with the key management service so that the appropriate certificates may be shared between the computing device and the remote key management service.

### SUMMARY

According to one embodiment, a self-encrypted drive (SED) setup system uses a systems manager executable program that stores user account information associated with an External Key Management Server (EKMS) service provided by an EKMS in which the user account information has a unique identifier of an associated Information Handling System (IHS). Using the stored user account information, the systems manager may setup a secure encrypted drive (SED) on the IHS by generating a Certificate Signing Request (CSR) for the IHS, communicate with a Certificate Authority (CA) associated with the EKMS to obtain a signed CSR and an EKMS certificate, and load the signed CSR and the EKMS certificate on the IHS when the IHS is to be registered for use with the EKMS. The EKMS service is configured to provide a key for the computing device.

According to another embodiment, a self-encrypted drive (SED) setup method includes the steps of storing user account information associated with an External Key Management Server (EKMS) service provided by an EKMS such that when the IHS is to be registered for use with the EKMS, the method may generate a Certificate Signing Request (CSR) for the IHS using the stored account information, communicate with a Certificate Authority (CA) associated with the EKMS to obtain a signed CSR and a EKMS certificate associated with the EKMS, and load the signed CSR and the EKMS certificate on the IHS. The user account information includes a unique identifier of an Information Handling System (IHS). Additionally, the EKMS service provides a key for the computing device.

According to yet another embodiment, a computer program product includes computer-executable program instructions for storing user account information associated with an External Key Management Server (EKMS) service provided by an EKMS in which the user account information includes a unique identifier of an Information Handling System (IHS). When the IHS is to be registered for use with the EKMS, the program instructions generate a Certificate Signing Request (CSR) for the IHS using the stored account information, communicate with a Certificate Authority (CA) associated with the EKMS to obtain a signed CSR and a EKMS certificate, and load the signed CSR and the EKMS certificate on the IHS.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram of examples of components of an Information Handling System (IHS) that may be used to implement a SED setup system and method according to one embodiment of the present disclosure.

FIG. 2 illustrates an example SED setup system that may be implemented on a computing environment according to one embodiment of the present disclosure.

FIG. 3 is a diagram view illustrating several components of an example SED setup system that may be used to setup a SED for use on a computing device according to one embodiment of the present disclosure.

FIG. 4 is a flowchart depicting certain steps of one embodiment of a SED setup method according to one embodiment of the present disclosure.

FIGS. 5A and 5B illustrate example windows that may be generated by the systems manager to implement the SED setup system according to one embodiment of the present disclosure.

### DETAILED DESCRIPTION

Embodiments of the present disclosure provide a self-encrypting drive (SED) setup system that stores information associated with a user account associated with an External Key Management Server (EKMS) such that, when the computing device is to be registered for use with the EKMS, the stored information is accessed to establish the necessary certificates for establishing a SED for use on the computing device. Additional embodiments include configuring the SED setup system on a systems manager, such as the OpenManage Enterprise systems manager provided by Dell Technologies, in the form of a plugin that may be installed for use with any existing systems manager implementation. Because the systems manager can manage and control multiple computing devices, the SED setup system may provide the ability to simultaneously register multiple EKMS-capable computing devices to be EKMS-ready so that a SED if provided for their respective computing devices.

Management of a large, diversified computing environment is typically provided by a remotely configured system management console. OpenManage Enterprise is one example of a systems manager provided by Dell Technologies, which cost-effectively facilitates comprehensive lifecycle management for the computing devices of distributed computing environments from a single console. While such systems management consoles have been an effective tool for remotely managing computing devices, their use with relatively large numbers of computing devices can sometimes be unwieldy. In many cases, for example, currently implemented computing devices are configured with SEDs to provide secure storage and access to data. SEDs, which comprise a part of hardware-based data encryption technology, can encrypt data as it is written to a storage medium and decrypt the data as it is read from the storage medium. A SED, for example, can use data encryption technology that involves data encryption (e.g., using an encryption key to transform a clear text to a cipher text), and data decryption (e.g., using the encryption key to transform cipher text into clear text).

Data security is an important problem in today’s networked computing environments. Recent history is replete with examples of data breaches of what otherwise should have been maintained securely. Network attached computing devices may be configured with SEDs using Local Key Management (LKM) techniques, but such techniques do not handle scenarios, such as theft or unsafe disposal in which the key used for accessing the data stored on the drive stays resident on the drive. Ideally Keys for data encryption may be stored on an External Key Management Server (EKMS) in which the keys used to encrypt the data are maintained at a remote location. Thus, even if a computing device is stolen or its drives were not properly wiped clean before disposal, the data cannot be retrieved. One particular example of an EKMS includes a Secure Enterprise Key Manager (SEKM) provided as part of the OpenManage Enterprise systems management appliance provide by Dell Technologies.

Nevertheless, setting up a computing device to function with an EKMS often involves a sequence of relatively complicated and error prone tasks. For example, to setup a computing device to function with an EKMS, a user (e.g., customer) typically purchases an EKMS license from the vendor, such as when the computing device is purchased. The vendor of the computing device, in turn, generates a user account with an EKMS service (e.g., Gemalto™), thus making the computing device EKMS-capable. At any time thereafter, such as when the user takes constructive possession of the computing device, it may be made EKMS-ready by performing a number of operations that can, and often do, fail if not conducted properly. Within this disclosure, the term ‘EKMS-capable’ refers to a state of a computing device in which a user account has been setup with an EKMS service for that computing device, while the term ‘EKMS-ready’ refers to a state of the computing device in which it is ready to begin functioning with an EKMS server to provide for secure storage of data on a SED. Embodiments of the present disclosure provide a solution to these problems, among others, via a SED setup system as will be described in detail herein below.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components.

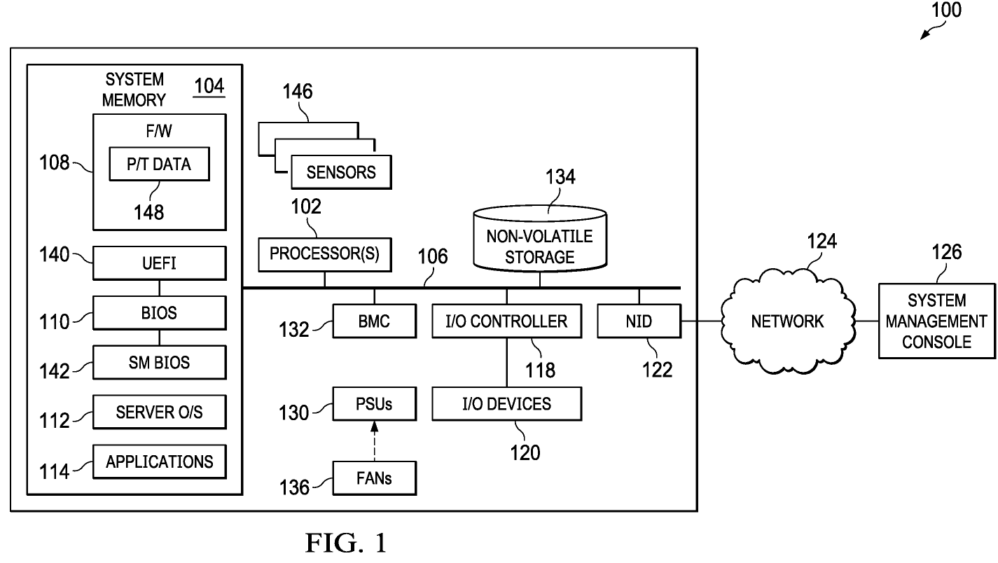

FIG. 1 is a block diagram of examples of components of an Information Handling System (IHS) that may be used to implement a SED setup system and method according to one embodiment of the present disclosure. Particularly, IHS 100 includes one or more processor(s) 102 coupled to system memory 104 via system interconnect 106. System interconnect 106 may include any suitable system bus. System memory 104 may include a plurality of software and/or firmware modules including firmware (F/W) 108, basic input/output system (BIOS) 110, operating system (O/S) 112, and/or application(s) 114. Software and/or firmware module(s) stored within system memory 104 may be loaded into processor(s) 102 and executed during operation of IHS 100.

F/W 108 may include a power/thermal profile data table 148 that is used to store power profile data and thermal profile data for certain hardware devices (e.g., processor(s) 102, system memory 104, non-volatile storage 134, NID 122, I/O controllers 118, etc.). System memory 104 may include a UEFI interface 140 and/or a SMBIOS interface 142 for accessing the BIOS as well as updating BIOS 110. In general, UEFI interface 140 provides a software interface between an operating system and BIOS 110. In many cases, UEFI interface 140 can support remote diagnostics and repair of computers, even with no operating system installed. SMBIOS interface 142 can be used to read management information produced by BIOS 110 of an IHS 100. This feature can eliminate the need for the operating system to probe hardware directly to discover what devices are present in the computer.

IHS 100 includes one or more input/output (I/O) controllers 118 which manages the operation of one or more connected input/output (I/O) device(s) 120, such as a keyboard, mouse, touch screen, microphone, a monitor or display device, a camera, a microphone, audio speaker(s) (not shown), an optical reader, a universal serial bus (USB), a card reader, Personal Computer Memory Card International Association (PCMCIA) slot, and/or a high-definition multimedia interface (HDMI), which may be included or coupled to IHS 100.

IHS 100 includes Network Interface Device (NID) 122. NID 122 enables IHS 100 to communicate and/or interface with other devices, services, and components that are located externally to IHS 100. These devices, services, and components, such as a system management console 126, can interface with IHS 100 via an external network, such as network 124, which may include a local area network, wide area network, personal area network, the Internet, etc.

For the purposes of this disclosure, term “system management console” may refer broadly to systems that are configured to couple to a management controller and issue management instructions for an information handling system (e.g., computing device) that is being managed by the management controller. One example of such a system management console is the Dell OpenManage Enterprise (OME) systems management console. In various embodiments, management consoles may be implemented via specialized hardware and/or via software running on a standard information handling system. In one embodiment, a system management console may be deployed on a secure virtual machine (VM), such as a VMWARE Workstation appliance.

IHS 100 further includes one or more power supply units (PSUs) 130. PSUs 130 are coupled to a BMC 132 via an I²C bus. BMC 132 enables remote operation control of PSUs 130 and other components within IHS 100. PSUs 130 power the hardware devices of IHS 100 (e.g., processor(s) 102, system memory 104, non-volatile storage 134, NID 122, I/O controllers 118, etc.). To assist with maintaining temperatures within specifications, an active cooling system, such as one or more fans 136 may be utilized.

IHS 100 further includes one or more sensors 146. Sensors 146 may, for instance, include a thermal sensor that is in thermal communication with certain hardware devices that generate relatively large amounts of heat, such as processors 102 or PSUs 130. Sensors 146 may also include voltage sensors that communicate signals to BMC 132 associated with, for example, an electrical voltage or current at an input line of PSU 130, and/or an electrical voltage or current at an output line of PSU 130.

BMC 132 may be configured to provide out-of-band management facilities for IHS 100. Management operations may be performed by BMC 132 even if IHS 100 is powered off, or powered down to a standby state. BMC 132 may include a processor, memory, and an out-of-band network interface separate from and physically isolated from an in-band network interface of IHS 100, and/or other embedded resources.

In certain embodiments, BMC 132 may include or may be part of a Remote Access Controller (e.g., a DELL Remote Access Controller (DRAC) or an Integrated DRAC (iDRAC)). In other embodiments, BMC 132 may include or may be an integral part of a Chassis Management Controller (CMC).

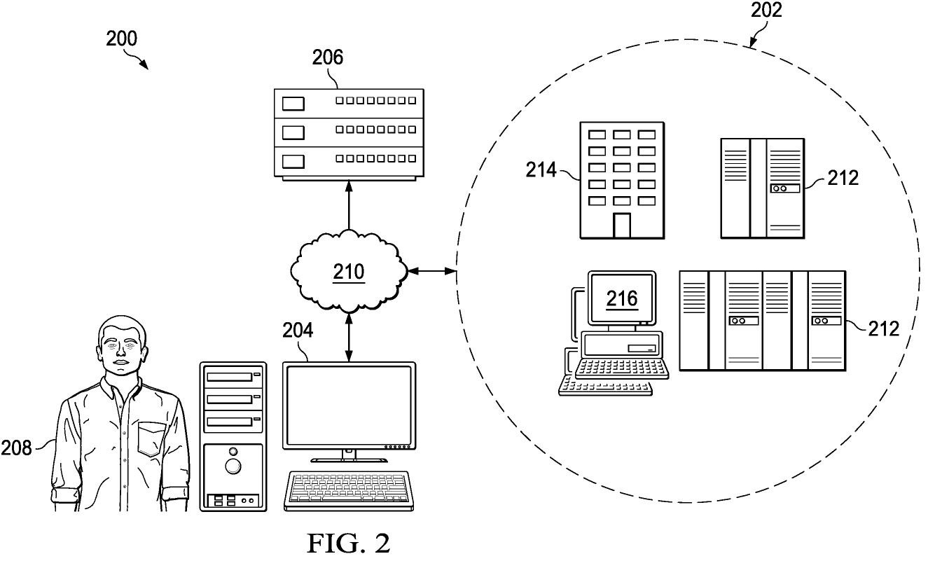

FIG. 2 illustrates an example SED setup system 200 that may be implemented on a computing environment according to one embodiment of the present disclosure. The SED setup system 200 generally includes a computing environment 202 that is managed by a systems management appliance 204. The SED setup system 200 also includes an EKMS server 206 that is used to distribute certificates and/or keys for implementing a SED on certain computing devices configured in the computing environment 202. As shown, the systems management appliance 204 communicates with the computing environment 202 through a network 210. Nevertheless, it should be appreciated that the systems management appliance 204 may communicate locally with the computing environment 202, or form a part of the computing environment 202.

In general, the systems management appliance 204 is configured to monitor and control any number of computing devices in the computing environment 202. In one embodiment, the systems management appliance 204 provides at least a portion of the features of the systems management console 126 described herein above. The computing environment 202 may include any type and quantity of computing devices, such as those that may be included in a computing cluster 212, a data center 214, or multiple computing devices 216 of an organizational entity, such as a business, or school. In one embodiment, certain computing devices of the computing cluster 212 and/or data center 214 may be similar in design and construction to the IHS 100 as described above with reference to FIG. 1.

In a particular example, computing environment 202 may be one managed by a single entity, such as a vendor of the computing devices, or some other large organization having a first computing cluster 212 located in Dallas, Texas, a second computing cluster 212 located in Houston, Texas, a data center 214 located in Atlanta, Georgia, and multiple computing devices 216 located in their home office in Austin, Texas. Thus, the number and type of computing devices managed by the systems management appliance 204 can, and often does, vary widely across the computing environment that it is designed to manage.

In many cases, currently implemented computing devices are configured with SEDs to provide secure storage and access to data. SEDs, which comprise a part of hardware-based data encryption technology, can encrypt data as it is written to a storage medium and decrypt the data as it is read from the storage medium. A SED, for example, can use data encryption technology that involves data encryption, which uses an encryption key to transform a clear text to a cipher text, and data decryption that uses the encryption key to transform cypher text back into clear text.

SED implementations use keys for data encryption that may be stored externally on an EKMS. Nevertheless, setting up a computing device to function with an EKMS often involves a complicated, error-prone sequence to register the SED for use. For example, to setup a computing device to function with an EKMS, a user (e.g., customer) typically purchases an EKMS license from the vendor. The computing device vendor, in turn, generates a user account with an EKMS service to make the computing device EKMS-capable. When the user takes possession of the computing device, it may be made EKMS-ready by performing a number of operations that is often a relatively time-consuming, tedious process. Embodiments of the self-encrypted drive (SED) setup system 200 stores information associated with a user account associated with an EKMS such that, when the computing device is to be registered for use with the EKMS server 206, the stored information is accessed to establish the necessary certificates for using a SED on that computing device.

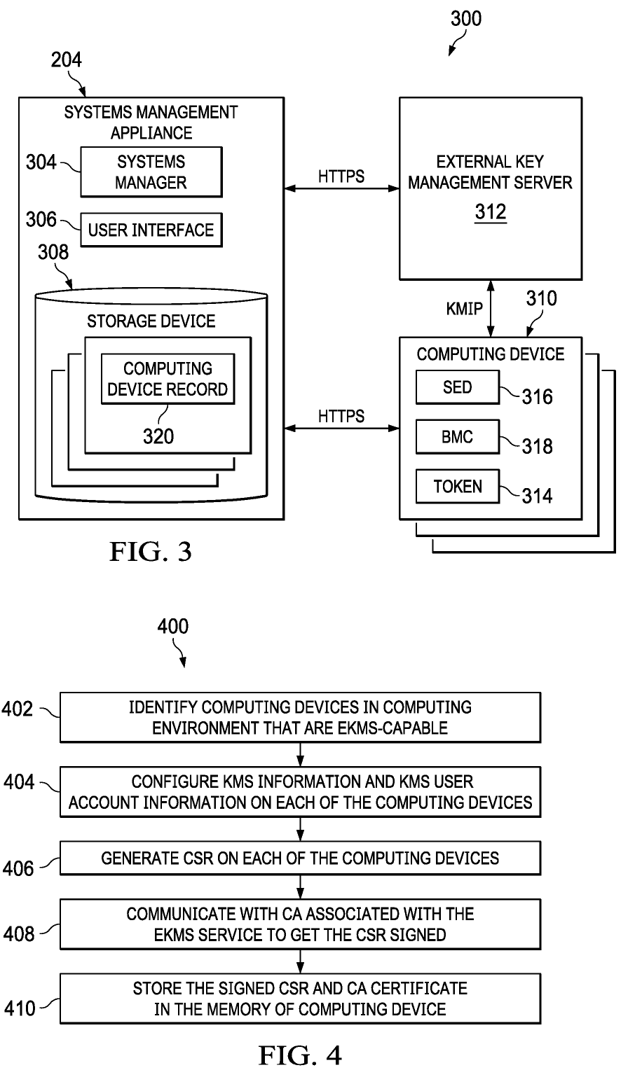

FIG. 3 is a diagram view illustrating several components of an example SED setup system 300 that may be used to setup a SED 316 for use on a computing device according to one embodiment of the present disclosure. The SED setup system 300 includes a systems management appliance 204 installed with a systems manager 304, a user interface 306, and a storage device 308, multiple computing devices 310, and an EKMS 312. In one embodiment, the user interface 306 provides at least a portion of the features of the systems management console 126 described herein above. The systems manager 304 monitors and controls the operation of computing devices 310. In one embodiment, systems manager 304 includes at least a portion of the Dell EMC OpenManage Enterprise (OME) that is installed on a secure virtual machine (VM), such as a VMWARE Workstation.

In one embodiment, the systems manager 304 communicates with the EKMS 312 and computing devices 310 via a HTTPS connection, while each of the computing devices 310 communicates with the EKMS 312 using a key management Interoperability protocol (KMIP) over a SSL/TLS secure connection. In general, the KMIP defines message formats for the manipulation of cryptographic keys on a key management server, such as the EKMS 312. The KMIP protocol supports both symmetric and asymmetric keys, including the ability to sign certificates. The KMIP protocol also allows for clients to request encryption or decryption of data without needing direct access to the key.

As shown, the computing device 310 is configured with a SED 316 and a baseboard management controller (BMC) 318. The BMC 318 generally includes a specialized microcontroller embedded in the computing device 310, and may provide an interface between system-management software and platform hardware. Different types of sensors built into the IHS report to the BMC on parameters such as temperature, cooling fan speeds, power status, operating system (O/S) status, and the like. The BMC monitors the sensors and can send alerts to a system administrator via the network if any of the parameters do not stay within pre-set limits, indicating a potential failure of the system. The administrator can also remotely communicate with the BMC 318 to take certain corrective actions, such as resetting or power cycling the system to get a hung O/S running again. These abilities can often save on the total cost of ownership of a computing device 310, particularly when implemented in large clusters, such as server farms.

Storage device 308 stores computing device records 320 that are each associated with a computing device 310 managed by the systems manager 304. Each computing device record 320 includes information about its associated computing device 310 in the computing environment 202. For example, each computing device record 320 may store user account information associated with the EKMS 312. The computing device record 320 may also store information about whether its associated computing device 310 is configured with a SED 316, and whether the SED 316 is EKMS-capable and/or EKMS-ready.

To make a computing device 310 EKMS-capable, a token 314 may be generated and stored in a hidden portion (e.g., BIOS) of the memory of the computing device 310. At later point in time, such as when the computing device 310 is placed in service, the systems manager 304 may make the computing device 310 EKMS-ready by performing certain operations, such as generating a certificate signing request (CSR) for the computing device 310 using the account information stored in the token 314, communicating with a certificate authority (CA) associated with the EKMS 206 to obtain a signed CSR and a EKMS certificate associated with the EKMS, and loading the signed CSR and the EKMS certificate on the IHS. In many cases, these operations often require certain formatting changes to the information so that the CSR will be in a form suitable for use by the EKMS 312. Additionally, if the computing device 310 is configured with a BMC 318, the systems manager 304 may load the received EKMS certificate and signed CSR into the BMC 318 so that it can administer the SED for the computing device 310.

Storage of the account information in the token 314 may provide certain advantages not heretofore recognized by conventional systems manager implementations. For example, the information necessary for establishing a SED-based account with an EKMS is simplified by ensuring the information always travels with the computing device where ever it goes. This aspect may be particularly beneficial given that data centers are often configured with hundreds if not thousands of computing devices whose EKMS-based credentials would be difficult to access and coordinate with an EKMS for implementing SEDs on those computing devices.

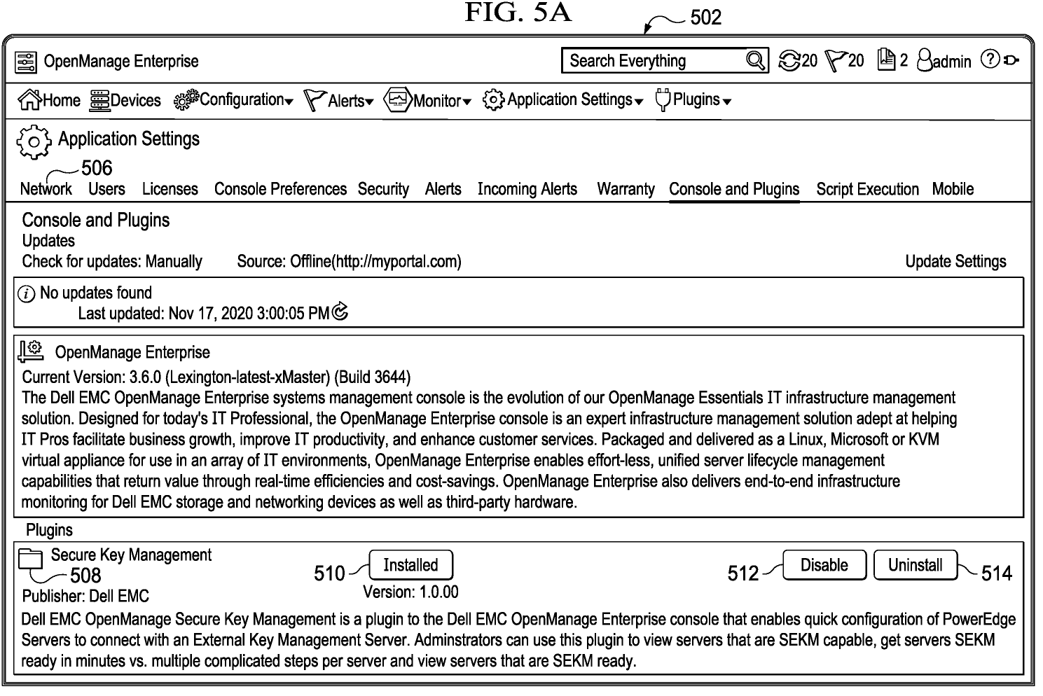

FIG. 4 is a flowchart depicting certain steps of one embodiment of a SED setup method 400 according to one embodiment of the present disclosure. In one embodiment, at least a portion of the steps of the method 400 may be performed by the systems manager 304 on a target computing device 310. In another embodiment, the method 400 may be performed by a plugin that may be installed for use with a previously installed systems manager 304. The method 400 may be performed for establishing an EKMS-based SED on a single computing device 310, and/or to any number of computing devices 310.

Initially, a user account is generated with an EKMS service, and information associated with the user account is stored in each of the computing devices 310. In one embodiment, the information is in the form a token 314 that is stored in a hidden portion of the memory of the computing device 310. Additionally, each of the computing devices 310 may be placed in service in that they have been configured with certain end-use applications, coupled to a communications network, and booted to commence their operation.

At step 402, the method 400 identifies one or more computing devices 310 in a computing environment 202 that are EKMS-capable. An EKMS-capable computing device 310 generally refers to one that has been registered with an EKMS service. For example, the method 400 may perform a discovery process in which each computing device 310 is checked to determine whether EKMS information (e.g., a token 314) exists thus indicating that it is EKMS-capable, and/or a signed CSR and CA certificate exists in the memory of the computing device 310 indicating that it is EKMS-ready. Additional details describing how the method 400 may identify EKMS-capable and EKMS-ready computing devices 310 are disclosed herein below.

At step 404, the method 400 configures KMS information and KMS user account information on each the computing devices 310 that are to be made EKMS-ready. If a computing device 310 is configured with a BMC 318, the method 400 may configure the KMS information and KMS user account information on the BMC 318. The KMS information may include a URL address of the EKMS server 206, user account information (e.g., username, password, etc.), a unique identifier (UID) (e.g., serial number) of the computing device 310, and any specific rights or restrictions that may be associated with the user account established between the user and the EKMS service. In one embodiment, the method 400 may access such information from the token 314 stored in the memory of the computing device 310. Thereafter at step 406, the method 400 generates a CSR on each of the computing devices 310, or on the BMC 318 if it is so equipped with one using the information configured at step 404. In one embodiment, the method 400 may perform any formatting changes to the information to place it in a form suitable for use by the EKMS service.

At step 408, the method 400 communicates with a CA associated with the EKMS service to get the CSR signed. In one embodiment, the method 400 may communicate with the CA of the EKMS using a HTTPS connection. The method 400, for example, may access the URL associated with the EKMS service, and send the CSR to the CA at that URL address. Additionally, the method 400 may perform any handshaking procedures and/or intermediary steps necessary for obtaining the signed CSR and CA certificate from the CA of the EKMS service. At step 410, the method 400 stores the signed CSR and CA certificate in a memory of the computing device 310. Optionally, if the computing device 310 is configured with and is controlled by a BMC 318, the method 400 may upload the signed CSR and CA certificate to the BMC 318. At this point, the computing device 310 is EKMS-ready and thus is ready to begin storing and accessing data to and from SED 316.

The steps of the aforedescribed method may be repeatedly performed for making other computing devices 310 EKMS-ready in the computing environment 202. Nevertheless, when use of the SED setup method 400 is no longer needed or desired, the process ends.

Although FIG. 4 describes an example method that may be performed for making a SED on a computing device available for use on a computing device 310, the features of the method 400 may be embodied in other specific forms without deviating from the spirit and scope of the present disclosure. For example, the method 400 may perform additional, fewer, or different operations than those described in the present examples. As another example, the steps of the aforedescribed process may be simultaneously performed on multiple computing devices 310 that are configured with SEDs 316.

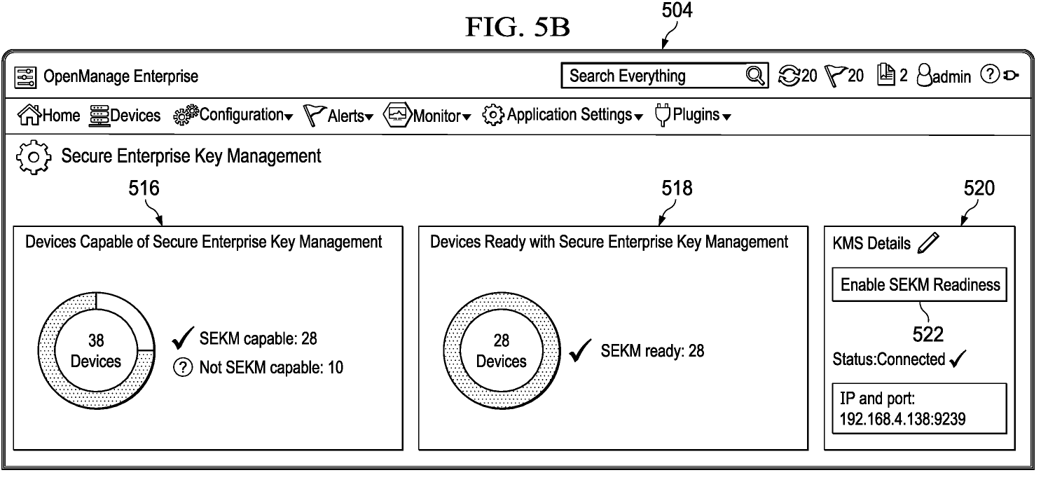

FIGS. 5A and 5B illustrate example windows that may be generated by the systems manager 304 to implement the SED setup system 200 according to one embodiment of the present disclosure. In particular, FIG. 5A illustrates a Console and Plugins window 502 that may display certain plugins that are installed for use with the systems manager 304, while FIG. 5B illustrates a EKMS management window 504 that may be accessed from the console and plugins window 502.

Referring now to FIG. 5A, the Console and Plugins window 502 may be displayed on user interface 306 of the systems management appliance 204, and includes a menu bar 506 with selectable menu items that, in this particular embodiment, includes a Network menu, a User menu, a License menu, a Console Preferences menu, a Security menu, an Alerts menu, an Incoming Alerts menu, a Warranty menu, a Console and plugins menu, a Script Execution menu, and a Mobile menu. As shown, the Console and Plugins window 502 is displayed because the Console and Plugins menu items has been selected by the user.

In general, the Console and Plugins menu window 502 displays one or more plugins that are installed for use with the systems manager 304. In this particular example embodiment, a Secure Key Management plugin 508 is shown as having been installed on the systems management appliance 204. The Secure Key Management plugin 508 includes an installed indicator 510 indicating that it is installed, and also provides an indication of the version that was installed. The Secure Key Management plugin 508 also includes a Disable selectable button 512 that when selected, causes the Secure Key Management plugin 508 to be disabled from use with the systems management appliance 204, and an Uninstall selectable button 514 that when selected, causes the Secure Key Management plugin 508 to be removed from the systems management appliance 204.

Referring now to FIG. 5B, the EKMS management window 504 may be shown as a result of selecting the Secure Key Management Plugin 508 from within the Console and Plugins window 502. The EKMS management window 504 includes a EKMS-capable window portion 516 and a EKMS-ready window portion 518. In general, the EKMS-capable window portion 516 shows how many computing devices 310 in the computing environment 202 managed by the systems manager 304 are EKMS-capable, while the EKMS-ready window portion 518 shows how many computing devices 310 in the computing environment 202 are EKMS-ready.

The Secure Key Management plugin 508 may identify how many EKMS-capable and EKMS-ready computing devices 310 exist using any suitable technique. In one embodiment, the Secure Key Management plugin 508 may identify those EKMS-capable and EKMS-ready computing devices 310 using a discovery process in which each computing device 310 in the computing environment 202 is checked to determine whether a computing device 310 includes information associated with a user account established with the EKMS service indicating that the computing device 310 is EKMS-capable, and/or a signed CSR and CA certificate indicating that the computing device 310 is EKMS-ready.

The EKMS management window 504 may also include a KMS Details window portion 520 that has a selectable EKMS action button 522 that when selected, causes the Secure Key Management plugin 508 to make all EKMS-capable computing devices 310 EKMS-ready simultaneously. For example, the Secure Key Management plugin 508 may perform the steps of the method 400 described herein above for each of the EKMS-capable computing devices 310 either sequentially or simultaneously. That is, the steps of the method 400 may be sequentially performed for each EKMS-capable computing device 310 and/or each step of the method 400 may be simultaneously performed for each EKMS-capable computing device 310 in the computing environment 202.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A self-encrypted drive (SED) setup system comprising:
a systems manager stored in at least one memory and executed by at least one processor to:
store user account information associated with an External Key Management Server (EKMS) service provided by an EKMS, the user account information including a unique identifier of an Information Handling System (IHS);
when the IHS is to be registered for use with the EKMS:
generate a Certificate Signing Request (CSR) for the IHS using the stored account information;
communicate with a Certificate Authority (CA) associated with the EKMS to obtain a signed CSR and a EKMS certificate associated with the EKMS; and
load the signed CSR and the EKMS certificate on the IHS;
wherein the EKMS service provides a SED for the computing device.

2. The SED setup system of claim 1, wherein the systems manager is further executed to store the user account information in a hidden memory storage of the IHS.

3. The SED setup system of claim 1, wherein the acts of generating a CSR, communicating with a CA, and loading the signed CSR and the EKMS certificate on the IHS are performed by a plugin that is stored in the at least one memory and executed by the at least one processor.

4. The SED setup system of claim 3, wherein the plugin is further executed to perform the acts of generating a CSR, communicating with a CA, and loading the signed CSR and the EKMS certificate on a plurality of the IHSs.

5. The SED setup system of claim 1, wherein the systems manager is further executed to:
identify from among a plurality of the IHSs, one or more EKMS-capable IHSs that possess the user account information; and
display information associated with the EKMS-capable IHSs for view by a user.

6. The SED setup system of claim 1, wherein the systems manager is further executed to:
identify from among a plurality of the IHSs, one or more EKMS-ready IHSs that possess the signed CSR and a EKMS certificate; and
display information associated with the EKMS-ready IHSs for view by a user.

7. The SED setup system of claim 1, wherein the systems manager is further executed to load the signed CSR and the EKMS certificate on a Baseboard Management Controller (BMC) of the IHS, wherein the BMC is configured to administer the operation of the SED.

8. A self-encrypted drive (SED) setup method comprising:
storing, using instructions stored in at least one memory and executed by at least one processor, user account information associated with an External Key Management Server (EKMS) service provided by an EKMS, the user account information including a unique identifier of an Information Handling System (IHS);
when the IHS is to be registered for use with the EKMS:
generating, using the instructions, a Certificate Signing Request (CSR) for the IHS using the stored account information;
communicating, using the instructions, with a Certificate Authority (CA) associated with the EKMS to obtain a signed CSR and a EKMS certificate associated with the EKMS; and
loading, using the instructions, the signed CSR and the EKMS certificate on the IHS;
wherein the EKMS service provides a SED for the computing device.

9. The SED setup method of claim 8, further comprising storing the user account information in a hidden memory storage of the IHS.

10. The SED setup method of claim 8, further comprising performing the acts of generating a CSR, communicating with a CA, and loading the signed CSR and the EKMS certificate on the IHS by a plugin that is stored in the at least one memory and executed by the at least one processor of the IHS.

11. The SED setup method of claim 10, further comprising performing, by the plugin, the acts of generating a CSR, communicating with a CA, and loading the signed CSR and the EKMS certificate on a plurality of the IHSs.

12. The SED setup method of claim 8, further comprising:
identify from among a plurality of the IHSs, one or more EKMS-capable IHSs that possess the user account information; and
display information associated with the EKMS-capable IHSs for view by a user.

13. The SED setup method of claim 8, further comprising:
identify from among a plurality of the IHSs, one or more EKMS-ready IHSs that possess the signed CSR and a EKMS certificate; and
display information associated with the EKMS-ready IHSs for view by a user.

14. The SED setup method of claim 8, further comprising loading the signed CSR and the EKMS certificate on a Baseboard Management Controller (BMC) of the IHS, wherein the BMC is configured to administer the operation of the SED.

15. A computer program product comprising a computer readable storage medium having program instructions embodied therewith, the program instructions executable by a processor to cause the processor to perform a method comprising:
storing user account information associated with an External Key Management Server (EKMS) service provided by an EKMS, the user account information including a unique identifier of an Information Handling System (IHS);
when the IHS is to be registered for use with the EKMS:
generating a Certificate Signing Request (CSR) for the IHS using the stored account information;
communicating with a Certificate Authority (CA) associated with the EKMS to obtain a signed CSR and a EKMS certificate associated with the EKMS; and
loading the signed CSR and the EKMS certificate on the IHS;
wherein the EKMS service provides a SED for the computing device.

16. The computer program product of claim 15, wherein the program instructions are further executed to store the user account information in a hidden memory storage of the IHS.

17. The computer program product of claim 15, wherein the acts of generating a CSR, communicating with a CA, and loading the signed CSR and the EKMS certificate on the IHS are performed by a plugin that is stored in the at least one memory and executed by the at least one processor.

18. The computer program product of claim 15, wherein the program instructions are further executed to:
identify from among a plurality of the IHSs, one or more EKMS-capable IHSs that possess the user account information; and
display information associated with the EKMS-capable IHSs for view by a user.

19. The computer program product of claim 15, wherein the program instructions are further executed to:
identify from among a plurality of the IHSs, one or more EKMS-ready IHSs that possess the signed CSR and a EKMS certificate; and
display information associated with the EKMS-ready IHSs for view by a user.

20. The computer program product of claim 15, wherein the program instructions are further executed to load the signed CSR and the EKMS certificate on a Baseboard Management Controller (BMC) of the IHS, wherein the BMC is configured to administer the operation of the SED.
